(19) United States
(12) Patent Application Publication
(10) Pub. No.: US 2023/0318178 A1
(43) Pub. Date: Oct. 5, 2023

(54) MULTI-ARRAY ANTENNA ARRANGEMENT

(71) Applicant: Cellmax Technologies AB, Kista (SE)

(72) Inventors: Dan KARLSSON, Sollentuna (SE); Stefan JONSSON, Ostersund (SE); Johan LUNDGREN, Storvreta (SE)

(21) Appl. No.: 17/712,662

(22) Filed: Apr. 4, 2022

(51) Int. Cl. H01Q 5/307; H01Q 1/24; H01Q 21/06; H01Q 15/14

(52) U.S. Cl. CPC H01Q 5/307; H01Q 1/246; H01Q 21/06; H01Q 15/14; H01Q 1/42

(57) ABSTRACT

A multi-array antenna arrangement comprising a backplane having a lower end and an upper end defining a height direction therebetween, at least one array comprising low-band radiating elements arranged at the front of the backplane, at least one array comprising mid-band radiating elements arranged at the front of the backplane, at least one array comprising high-band radiating elements arranged at the front of the backplane in the vicinity of the upper end thereof, wherein at least one of the low-band and/or mid-band radiating elements is arranged at equal or higher height than an uppermost of the high-band radiating elements.

### TECHNICAL FIELD

The present invention relates to the field of base station antennas for mobile communication.

### BACKGROUND

Base station antennas for mobile communication normally comprise an antenna feeding network, a backplane and a plurality of radiating elements (for example dipoles) arranged in front of the backplane. The backplane typically comprises an electrically conductive reflector onto which, or in front of which, the radiating elements are arranged.

Radiating elements are commonly placed as an array in front of the backplane, in some cases as a one-dimensional array extending in the vertical direction, but also two-dimensional arrays are used.

The purpose of the antenna feeding network is to distribute the signals from a common connector to all radiating elements of an array when transmitting, and combining the signals from all the radiating elements to the same common connector when receiving. Such an antenna feeding network can be realized using flexible coaxial cables using e.g. PTFE (polyfluoroethylene) as dielectric between inner and outer conductor, or air-filled coaxial lines as disclosed in WO2005/101566A1, or stripline technology with a flat conductor being placed between two ground planes, or microstrip technology using a flat conductor placed over a ground plane, or any other transmission line technology or a combination of the technologies cited above. In all those cases, it is possible to use a dielectric as e.g. PTFE between the conductor and the ground plane, or just air. The latter will result in significantly lower losses.

As the number of frequency bands used at for mobile communication has increased over the years, it has become advantageous to re-group arrays of radiators aimed at different frequency bands into a multi-band antenna. A common solution is to have a Low-Band array of radiators covering several frequency bands (for instance for the frequency range below 1 GHz, such as 600-1000 MHz) combined with one or more Mid-Band array of radiators (for instance for the frequency range 1-3 GHz) into a multi-band antenna. Such multi-band antennas can be implemented using antenna feeding networks as disclosed in WO2005/101566A1. An example of such a multi-band antenna is disclosed in WO2014/120062A1. These antennas comprise one low-band array and two mid-band arrays (referred to as high-bands arrays therein). The common reflector (or backplane) and the feeding networks are all formed from a single extruded aluminium profile. As new frequency bands have now been released for cellular communication, the need for High-Band antennas, typically covering a frequency band above 3.0 GHz, has arisen. Advantageously, high-band array(s) of radiators is/are combined with one or more low-band arrays of radiators and one or more mid-band array of radiators into a multi-band antenna.

U.S. Pat. No. 10,270,159B1 discloses multi-band antennas units which have one first antenna which includes a Low Band array of radiators and a Mid Band array of radiators and one second antenna having a High Band array of radiators, and where the second antenna is mounted vertically stacked above the first antenna. In an embodiment, the two stacked antennas share a common radome.

The propagation performance for different frequency bands varies considerably. Typically, lower frequency bands are used in order to maximize coverage. But the available bandwidth at lower frequency bands is limited, so higher frequency bands are used to enhance the capacity of cellular site. As an example, a typical cellular site can today have means for communicating in the 700 MHz, 850 MHz, 1900 MHz, 2500 MHz and 3500 MHz bands. The frequency band each operator uses depends on which licenses he has acquired. Depending on how the operator implements his network, the requirement on the antenna will be different. Those different requirements can be e.g. the number of elements in a vertical array, the number of columns, the efficiency of the feeding network, multilobe functionality etc.

As an example, increasing the number of radiators in an array will increase the antenna gain and hence the coverage. In some cases, high gain at Mid Band might be required, and hence the number of radiators must be increased. If a second High Band is added above the Mid band array, the antenna may be higher than what is allowed on a site, or the site rental cost may be increased as it in some cases is based on antenna height. Using two antennas may also increase the site rental cost. At higher frequency bands such as the 3500 MHz band, it is more important to have line-of-sight between the base station antenna and a mobile equipment such as a mobile phone. By putting the high band radiators as high as possible it is possible to avoid some obstacles which could otherwise have impaired the quality of the communication channel.

### SUMMARY

An object of the invention is to solve or improve on at least some of the problems mentioned above in the background section.

These and other objects are achieved by the present invention by means of a multi-array antenna arrangement according to the independent claim.

According to a first aspect of the invention, a multi-array antenna arrangement is provided. The antenna arrangement comprises a backplane having a lower end and an upper end defining a height direction therebetween, at least one array comprising low-band radiating elements arranged at the front of the backplane, at least one array comprising mid-band radiating elements arranged at the front of the backplane, at least one array comprising high-band radiating elements arranged at the front of the backplane in the vicinity of the upper end thereof, wherein at least one of the low-band and/or mid-band radiating elements is arranged at equal or higher height than an uppermost of the high-band radiating elements.

It is understood that the backplane normally has a substantially rectangular shape, and the height direction thus coincides with the longitudinal direction of the backplane, which may also be referred to as a vertical direction assuming a vertical orientation of the antenna arrangement/backplane. At least one of the array(s) comprising low-band radiating elements and/or at least one of the array(s) comprising mid-band radiating elements may be vertically-disposed linear array(s), for example one-dimensional array(s) extending in the vertical direction, i.e. array(s) each formed as a column of radiating elements extending in the height direction of the backplane. The at least one array comprising high-band radiating elements is typically formed as a two-dimensional array, for example in the form of at least two parallel columns of radiating elements. At least one of the array(s) comprising low-band radiating elements and/or at least one of the array(s) comprising mid-band radiating elements may also be formed as such two-dimensional array(s). It is furthermore understood that the low-band radiating elements are configured to transmit and receive signals at one or more first frequency bands, for example being below 1 GHz, and that the mid-band radiating elements are configured to transmit and receive signals at one or more second frequency bands being for example within an interval from 1.0-3.0 GHz, and that the high-band radiating elements are configured to transmit and receive signals at one or more third frequency bands, for example being above 3.0 GHz. The radiators of the arrays may be cross-polarized. It is furthermore understood that the term indirect electrical connection referred to below refers to an electrical connection which is capacitive and/or inductive, which stands in contrast with a direct electrical connection, i.e. a galvanic electrical connection.

The invention is based on the insight that available space in front of the backplane can be used more efficiently if the low-band and/or mid-band arrays extend to equal height as the high-band array(s) or, in some cases, to a higher height than the high-band array(s). For example, if the backplane is allowed to be wider than the necessary width needed for the high-band array, the left-over backplane space at one or both lateral sides of the high-band array can be populated by low-band and/or mid-band radiating elements extending all the way up to the upper end of the backplane.

In embodiments, at least one low-band and/or mid-band radiating element may be arranged with its base at equal or higher height than the base of the uppermost of the high-band radiating elements. More specifically, the at least one low-band and/or mid-band radiating element may be arranged with its base attached to the backplane at a position being at equal or higher height than the position where the base of the uppermost of the high-band radiating elements is attached to the backplane.

In embodiments, at least one of the mid-band radiating elements may be arranged at equal or higher height than an uppermost of the high-band radiating elements. In such an embodiment, the uppermost ones of the low-band radiating elements may be arranged at lower, equal or higher height than the uppermost of the high-band radiating elements. These embodiments are advantageous when a high gain at the mid-band is required, which implies a large number of mid-band radiating elements. Since no high-band and/or low-band radiating elements are arranged above the uppermost mid-band radiating element(s), the overall height of the antenna will be determined by the height of the mid-band array(s), and thus the height will be minimized.

In embodiments, one or more of the at least one array comprising low-band radiating elements and/or one or more of the at least one array comprising mid-band radiating elements may be arranged on at least one lateral side of one or more of the at least one array comprising high-band radiating elements. Advantageously, first and second arrays comprising low-band and/or mid-band radiating elements are arranged at both/opposite lateral sides of one or more of the at least one array comprising high-band radiating elements. These embodiments allow backplane space at one or both lateral sides of the high-band array to be used, thus providing improved use of backplane space in case the backplane is allowed to be wider than the necessary width needed for the high-band array. In embodiments, the antenna arrangement further comprises at least one third array, each being one or more of the at least one array comprising low-band radiating elements and/or one or more of the at least one array comprising mid-band radiating elements, which third array is arranged below one or more of the at least one array comprising high-band radiating elements. The third array may be arranged below the array(s) comprising high-band radiating elements and between the first and second arrays of low-band and/or mid-band radiating elements.

In the embodiments described above, the array(s) comprising low-band and/or mid-band radiating elements arranged at lateral side(s) of the high-band array(s) may be elongated and arranged in the height/vertical direction, for example in the form of a single column of radiating elements.

In embodiments, at least one of the arrays may comprise low-band and mid-band radiating elements in the form of combined radiating elements, each combined radiating element having low-band radiating parts and mid-band radiating parts. It is understood that such a combined radiating element refers to a radiating element module which functions as both a low-band radiating element and as a mid-band radiating element. Combined radiating elements are known in the art. U.S. Pat. No. 6,333,720 discloses how two cross-polarized radiating elements can be combined to form a combined radiating element. In embodiments, the at least one array comprising combined radiating elements may furthermore comprise mid-band-only radiating elements which are interleaved with the combined radiating elements. This embodiment may be advantageous as the width of the antenna is reduced compared to using two arrays, one with low-band elements and one with mid-band elements.

In embodiments, the backplane may be formed by at least two parts. The at least two parts may, but do not necessarily need to, be electrically interconnected. More specifically, the backplane may comprise at least two electrically conducting reflector parts, each being configured to co-act with at least one of the arrays. At least two of the electrically conducting reflector parts may be directly and/or indirectly electrically interconnected. The backplane may comprise one or more first reflector parts which are arranged to co-act with at least one array comprising low-band radiating elements and/or with at least one array comprising mid-band radiating elements, and one or more second reflector parts arranged to co-act with at least one array comprising high-band radiating elements. At least one of the second reflector part(s) may be arranged with a lateral side facing at least one first reflector part. For example, first reflector part(s) may be arranged at lateral side(s) of a second reflector part. Alternatively, a first reflector part may be provided with a cut-out portion, for instance at an upper end thereof, the first reflector part being configured to receive a second reflector part in the cut-out portion.

In embodiments, at least two first reflector parts may each be arranged to co-act with at least one array comprising low-band radiating elements and/or at least one array comprising mid-band radiating elements, the at least two first reflector parts being directly or indirectly electrically interconnected.

In embodiments, at least one first reflector part and at least one second reflector part may be directly and/or indirectly electrically interconnected. In other words, at least one reflector part co-acting with a low- and/or mid-band array and at least one reflector part co-acting with a high-band array may be directly or indirectly electrically interconnected and thus form a common ground plane.

In embodiments, at least one reflector part along with at least one array of radiating elements may form part of a multi-radiator antenna having its reflector formed partly by the reflector part and partly by one or more adjacent reflector parts. In other words, the radiating elements use not only the reflector part in front of which they are arranged (or attached) as its reflector; the radiating elements interact also with one or more adjacent reflector parts in such a way as to form a larger reflector than the reflector part to which the antenna elements are attached. This is advantageous since the overall width of the reflector can be reduced compared to if adjacent reflector parts would not be used to form larger (effective) reflector.

In embodiments comprising two or more electrically conducting reflector parts, at least two of the reflector parts are each provided with at least one connecting portion, and the multi-array antenna arrangement further comprises at least one connector device adapted to provide an electrical interconnection between the at least two of the reflector parts. Each connector device comprises:
a metallic film adapted to be arranged in abutment with connecting portions of the at least two of the reflector parts to achieve the electrical interconnection, and
one or more holding elements, wherein at least one of the holding elements has at least one holding portion adapted to connect to a connecting portion of a reflector part with the metallic film sandwiched therebetween,
   wherein the electrical interconnection is indirect by means of a dielectric coating or layer arranged on the metallic film and/or on the connecting portions, or by means of a dielectric film arranged between the metallic film and the connecting portions. The above-mentioned first reflector parts may be indirectly interconnected with each other, or one or more first reflector parts may be indirectly interconnected with at least one of the above-mentioned second reflector parts in the manner described above using connector device(s) connecting to connecting portion(s) of the first/second reflector parts,

In embodiments, the multi-array antenna arrangement may further comprise at least one antenna feeding network module, wherein one or more of the at least one array comprising low-band radiating elements and/or one or more of the at least one array comprising mid-band radiating elements or one or more of the at least one array comprising high-band radiating elements is electrically connected to the antenna feeding network module. The antenna feeding network may be arranged at a back side of one or more reflector parts co-acting with one or more of the at least one array comprising low-band and/or with one or more of the at least one array comprising mid-band radiating elements and/or with one or more of the at least one array comprising high-band radiating elements. Further, the antenna feeding network may be formed integrally with the one or more reflector parts, for example as disclosed in WO2005/101566A1 or WO2014/120062A1, which are hereby incorporated by reference. The antenna feeding network module(s) may be provided with a phase shifting arrangement. In embodiments where the antenna feeding network module comprises at least one transmission line being a coaxial line having at least one inner conductor being at least partly surrounded by an elongated outer conductor with air therebetween, a dielectric element may be provided between the inner and outer conductors. The phase shift is achieved by moving the dielectric element. If the dielectric element is moved in such a way that the outer conductor will be more filled with dielectric material, the phase shift will increase. The phase shifting arrangement may be of the type disclosed in U.S. Pat. No. 8,576,137 B2 or U.S. Pat. No. 10,389,039 B2, which are both hereby incorporated by reference. The phase shifters can be used to control the antenna beam elevation, this is commonly referred to as electrical tilt. The phase shifters may be controlled remotely by adding an actuator such as an electrical motor. Each array may be controlled individually, either by using several actuators, or by using connecting means (a linkage for example) connecting one actuator to a set of phase shifters at a time, each set of phase shifter controlling the beam elevation of each radiator column or two-dimensional array of radiators.

In embodiments, the radiating elements of at least one of the arrays may be separated by less than one wavelength. The radiating elements of two columns of radiating elements may be separated by at least half a wavelength. For example, a first column of radiating elements of one of the low-, mid- or high-band arrays may be separated by at least half a wavelength from a second column of radiating elements of one of the low-, mid- or high-band arrays. The first and second columns of radiating elements may be part of the same array or two different arrays.

In embodiments, the arrays of low-band, mid-band and high-band radiating elements may be arranged behind a radome. More specifically, at least one array comprising low-band and/or mid-band radiating elements and at least one array comprising high-band radiating elements may be arranged behind a common radome. In embodiments, all arrays of low-band, mid-band and high-band radiating elements are arranged behind a common radome.

According to a second aspect of the invention, a system for cellular communication is provided. The system comprises at least one mobile communication device (such as a cellular phone) and at least one multi-array antenna arrangement according to the first aspect of the invention or embodiments thereof.

The features of the embodiments described above are combinable in any practically realizable way to form embodiments having combinations of these features. Further, all features and advantages of embodiments described above with reference to the first aspect of the invention may be applied in corresponding embodiments of the second aspect of the invention.

### BRIEF DESCRIPTION OF THE DRAWINGS

Above discussed and other aspects of the present invention will now be described in more detail using the appended drawings, which show presently preferred embodiments of the invention, wherein:

FIG. 1 a schematically shows a front view of an embodiment of a multi-array antenna arrangement according to the invention;

FIG. 1b schematically shows a front view of an embodiment of a multi-array antenna arrangement according to the invention;

FIG. 1c schematically shows a front view of an embodiment of a multi-array antenna arrangement according to the invention;

FIG. 1d schematically shows a front view of an embodiment of a multi-array antenna arrangement according to the invention;

FIG. 2 schematically shows a front view of an embodiment of a multi-array antenna arrangement according to the invention, the antenna arrangement comprising a separate high-band reflector part;

FIG. 2a schematically shows a cross section view of a lower portion of the antenna arrangement in FIG. 2;

FIG. 2b schematically shows a cross section view of an upper portion of the antenna arrangement in FIG. 2;

FIG. 3 schematically shows a front view of an embodiment of a multi-array antenna arrangement according to the invention, the antenna arrangement comprising separate low-band, mid-band and high-band reflector parts;

FIG. 3a schematically shows a cross section view of a lower portion of the antenna arrangement in FIG. 3;

FIG. 3b schematically shows a cross section view of an upper portion of the antenna arrangement in FIG. 3;

FIG. 3c schematically shows a detail view of the interconnection between the low-band and mid-band reflector parts in FIG. 3b;

FIG. 4 schematically shows a cross section view of a lower portion of an antenna arrangement corresponding to FIG. 3 except that the antenna feeding network modules comprise striplines, and that it is shown with a radome, and

FIG. 5 schematically shows a front view of an embodiment of a multi-array antenna arrangement corresponding to FIG. 3 except being shown with a radome being common for all arrays/reflector parts.

### DETAILED DESCRIPTION

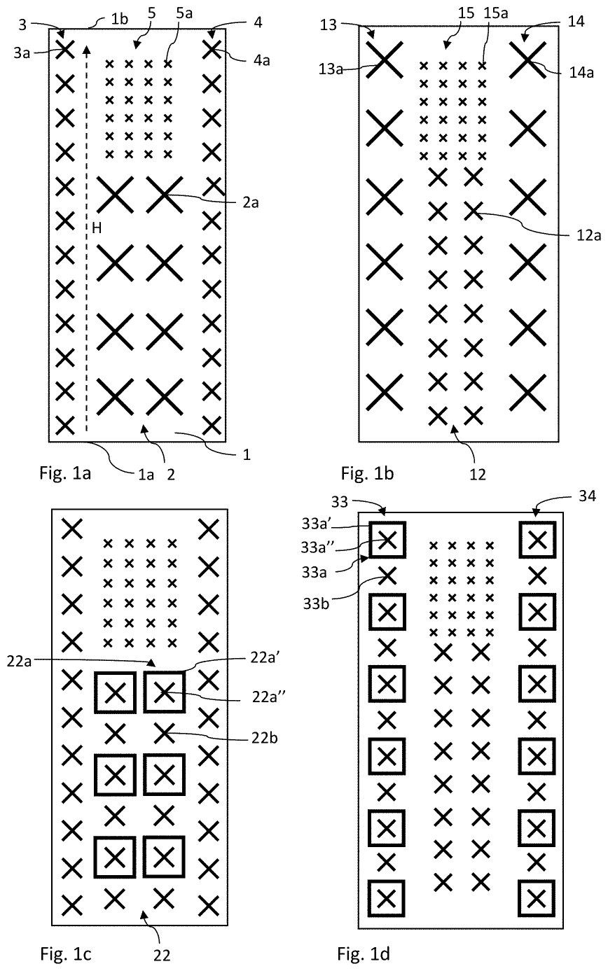

FIG. 1 a schematically shows a front view of an embodiment of a multi-array antenna arrangement according to the invention. The multi-array antenna arrangement comprises a backplane 1 having a lower end 1a and an upper end 1b defining a height direction H therebetween (indicated by the dotted arrow). The backplane 1 functions as a reflector and ground plane for the radiating elements (2a, 3a, 4a and 5a for example), and is shown schematically as a rectangle. The radiating elements are illustrated schematically as crosses and may for example be four-leaf clover type dipole radiators, cross-type dipole radiators or other types of dual polarized radiating elements. One array 2 of low-band radiating elements (2a for example) is arranged at the front of the backplane, which array comprises two columns of low-band radiating elements arranged vertically (in parallel with the height direction). Two arrays 3, 4 of mid-band radiating elements (3a and 4a for example) are arranged at the front of the backplane, each mid-band array comprising one column of mid-band radiating elements arranged vertically (in parallel with the height direction). One array 5 of high-band radiating elements (5a for example) is arranged at the front of the backplane in the vicinity of the upper end 1b thereof. The high-band array comprises four columns of high-band radiating elements. Uppermost ones 3a, 4a of the mid-band radiating elements are arranged at higher height than uppermost ones (5a for example) of the high-band radiating elements. Further, as can be seen in FIG. 1a, the arrays 3 and 4 of mid-band radiating elements are arranged at opposite lateral sides of the array 5 of high-band radiating elements. The array 2 of low-band radiating elements is arranged below the array 5 of high-band radiating elements and between arrays 3 and 4 of mid-band radiating elements. Other embodiments correspond to FIG. 1a except that it comprises a different number of columns in the low-band array, for instance one or three columns, and/or a different number of columns in the high-band array, and/or a different number of columns in the mid-band arrays and/or a different number of radiators in one or more of the arrays.

FIG. 1b schematically shows a front view of an embodiment of a multi-array antenna arrangement according to the invention. This embodiment corresponds to the embodiment in FIG. 1a except that the arrays 13 and 14 (at opposite lateral sides of the high-band array 15) comprise low-band radiating elements, and in that the array 12 (arranged below the array 15 of high-band radiating elements) comprises mid-band radiating elements (12a for example). The array 12 is also arranged between arrays 13 and 14 of low-band radiating elements. Uppermost ones 13a, 14a of the low-band radiating elements are arranged at higher height than uppermost ones (15a for example) of the high-band radiating elements. More specifically, the uppermost ones 13a, 14a of the low-band radiating elements are arranged with their bases (the centers of the crosses 13a, 14a in the schematic illustration in FIG. 1b) at higher height than the base (the center of cross 15a) of the uppermost 15a of the high-band radiating elements. The embodiment in FIG. 1b, being provided with a larger number of low-band radiating elements than in FIG. 1a, is advantageous for example in a deployment scenario where the low band is used to achieve a maximum coverage area. Other embodiments correspond to FIG. 1b except that it comprises a different number of columns in the low-band arrays, for instance two columns, and/or a different number of columns in the high-band array, and/or a different number of columns in the mid-band array, for instance one or three columns.

FIG. 1c schematically shows a front view of an embodiment of a multi-array antenna arrangement according to the invention. This embodiment corresponds to the embodiment in FIG. 1a except that the array of low-band radiating elements has been replaced with an array 22 of two columns of interleaved combined radiating elements (22a for example) and mid-band radiating elements (22b for example). Each combined radiating element comprises low-band radiating parts represented as a square (22a′ for example) and mid-band radiating parts (22a″ for example). Combined radiating elements are well-known in the art and will not be described in further detail herein. The array 22 can thus be said to comprise low-band and mid-band radiating elements. Other embodiments correspond to FIG. 1c except that it comprises a different number of columns in the mid-band arrays, for instance two columns, and/or a different number of columns in the high-band array, and/or a different number of columns in the array of interleaved combined radiating elements and mid-band radiating elements, for instance one, three or four columns.

FIG. 1d schematically shows a front view of an embodiment of a multi-array antenna arrangement according to the invention. This embodiment corresponds to the embodiment in FIG. 1b except that the arrays of low-band radiating elements have been replaced with arrays 33, 34, each comprising one column of interleaved combined radiating elements (33a for example) and mid-band radiating elements (33b for example). Each combined radiating element comprises low-band radiating parts (33a′ for example) and mid-band radiating parts (33a″ for example). Combined radiating elements are well-known in the art and will not be described in further detail herein. The array 33 can thus be said to comprise low-band and mid-band radiating elements. Other embodiments correspond to FIG. 1d except that it comprises a different number of columns in the mid-band arrays, for instance two columns, and/or a different number of columns in the high-band array, and/or a different number of columns in the arrays of interleaved combined radiating elements and mid-band radiating elements, for instance one or three columns. Further, the arrays 33, 34 do not necessarily need to comprise mid-band-only radiating elements but may comprise solely interleaved radiating elements.

A base station antenna is usually connected to a number of Node B or base station transceivers, typically one for each band used, The antennas in FIGS. 1c and 1d may accommodate one Low band, e.g. the 850 MHz band, and two Mid band Node B, e.g. the 1900 MHz and 2500 MHz bands, with 4 channel MIMO (multiple input multiple output), and one High band Node B with 8 channel MIMO. By using interleaved radiating elements in all four Mid band columns, it would be possible to add also the 700 MHz band with 4 channel MIMO.

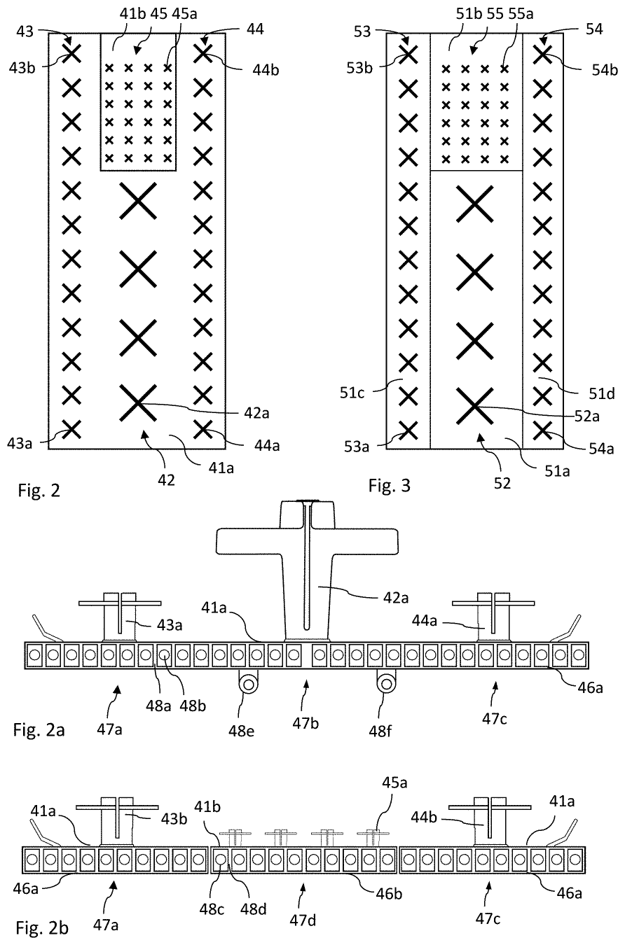

FIG. 2 schematically shows a front view of an embodiment of a multi-array antenna arrangement according to the invention. This embodiment corresponds to the embodiment in FIG. 1a except that the array 42 of low-band radiating elements only comprises one column, and in that the backplane comprises two electrically conducting (reflector) parts; a first reflector part 41a and a second reflector part 41b. The mid-band radiating elements of arrays 43, 44 and the low-band radiating elements of array 42 are attached to the first reflector part 41a to form one low-band and two mid-band antennas. The high-band radiating elements of array 45 are attached to the second reflector part 41b to form a high-band antenna. The upper part of the first reflector part 41a is formed with a rectangular cut-out portion in which the second reflector part 41b is arranged with its front surface flush with the front surface of the first reflector part 41a. In other embodiments, the second reflector part may be arranged with its front surface in front of the first reflector part, i.e. the second reflector parts protrudes in front of the first reflector part.

FIG. 2a schematically shows a cross section view of a lower portion of the antenna arrangement in FIG. 2 (with more details shown than in FIG. 2). The cross section is taken just below mid-band radiating elements 43a, 44a, which means that low-band radiating element 42a can also be seen. Further, as can be seen in FIG. 2a, the first reflector part 41a is formed integrally with an antenna feeding network module as an extruded aluminium profile 46a. The antenna feeding network module comprises a plurality of parallel of substantially air-filled coaxial transmission lines, each formed by an outer conductor (48a for example) being formed by the aluminium profile 46a and an inner conductor (48b for example). The antenna feeding network module forms an antenna feeding network 47a for array 43, an antenna feeding network 47b for array 42, and an antenna feeding network 47c for array 44. Although not shown in FIG. 2a, it is understood that the antenna feeding network module is furthermore provided with coaxial connectors, for example of the type described in US2019051961, which is also incorporated by reference.

FIG. 2b schematically shows a cross section view of an upper portion of the antenna arrangement in FIG. 2 (with more details shown than in FIG. 2). The cross section is taken just below high-band radiating element 45a (and the parallel high-band radiating elements of adjacent columns), which means that mid-band radiating elements 43b, 44b can also be seen. The second reflector part 41b is formed integrally with an antenna feeding network module 47d as an extruded aluminium profile 46b. Further, as can be seen in FIG. 2b, the second reflector part 41b (aluminium profile 46b) is arranged with its lateral sides facing the first reflector part 41a (aluminium profile 46a). The second reflector part 41b is arranged adjacent the first reflector part 41a but is not arranged in electrical contact therewith. In other embodiments, the first and second reflector parts may be in direct or indirect electrical contact. An antenna feeding network module 47d is schematically shown below the second reflector part 41b and comprises a plurality of parallel of substantially air-filled coaxial transmission lines, each formed by an outer conductor (48d for example) being formed by aluminium profile 46b and an inner conductor (48c for example), which coaxial transmission lines are connected to the high-band radiating elements. In FIG. 2b, the antenna feeding network module 47d is shown with ten compartments/outer conductors, but this is only for illustrative purposes. The number of transmission lines and the configuration thereof varies depending on the requirements. The antenna feeding network below reflector part 41b is connected to (not shown) coaxial connectors at the bottom of the antenna arrangement via flexible coaxial cables 48e, 48f using for instance PTFE (polytetrafluoroethylene) or PE (polyethylene) as dielectric. As can be seen in FIG. 2a, the flexible coaxial cables extend behind the aluminum profile 46a, i.e. behind the antenna feeding network 47b for the low-band array 42. In FIG. 2a, two flexible coaxial cables are shown, but this is only for illustrative purposes. The number of cables and the configuration thereof varies depending on the requirements. Although the reflector parts 41a, 41b are formed as separate parts, the low- and mid-band radiating elements arranged on the first reflector part 41a will to some extent make use also of the second reflector part 41b. Thus, the low- and mid-band antennas are formed by the low- and mid-band radiating elements and the first and second reflector parts. In the same manner, the high-band antenna is formed by the high-band radiating elements and the first and second reflector parts.

The antenna feeding networks shown in FIGS. 2a and 2b, the interconnection of the coaxial lines and the interconnection between the antenna feeding elements and the coaxial lines is described in more detail in applicants' previous publications US2019058261, US2019051960 and US2018277958, which are hereby incorporated by reference.

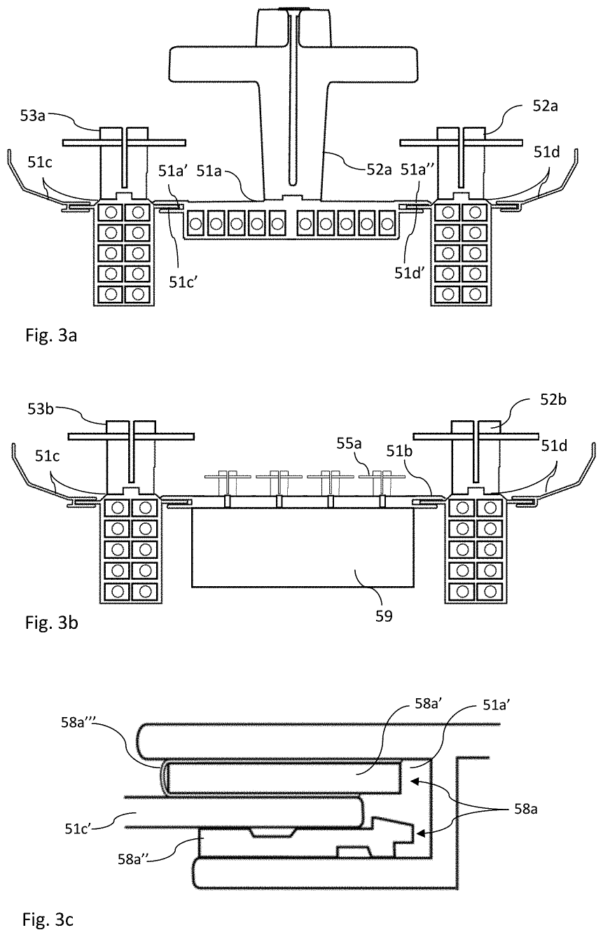

FIG. 3 schematically shows a front view of an embodiment of a multi-array antenna arrangement according to the invention. This embodiment corresponds to the embodiment in FIG. 2 except that the backplane comprises four electrically conducting reflector parts (a first reflector part 51a, a second reflector part 51b and third/fourth reflector parts 51c, 51d). The low-band radiating elements of array 52 are attached to the first reflector part 51a to form a low-band antenna. The mid-band radiating elements of arrays 53 and 54 are attached to the third and fourth reflector parts 51c, 51d, respectively to form two mid-band antennas. The high-band radiating elements of array 55 are attached to the second reflector part 51b to form a high-band antenna. The first and second reflector parts 51a, 51b have the same lateral width and are arranged vertically stacked with the third and fourth reflector parts 51c, 51d disposed at opposite lateral sides thereof.

FIG. 3a schematically shows a cross section view of a lower portion of the antenna arrangement in FIG. 3 (with more details shown than in FIG. 3). The cross section is taken just below mid-band radiating elements 53a, 54a, which means that low-band radiating element 52a can also be seen. Further, as can be seen in FIG. 3a, the first, third and fourth reflector parts 51a, 51c, 51d are each formed integrally with a respective antenna feeding network module as an extruded aluminium profile. Each antenna feeding network module comprises a plurality of parallel of substantially air-filled coaxial transmission lines in a similar manner as in FIG. 2a, but unlike in FIG. 2a-b, they are disposed substantially perpendicular to the corresponding reflector part in the sense that the inner conductors of the coaxial lines are disposed in two parallel planes which are substantially perpendicular to the corresponding reflector part. The reflector parts 51c, 51a and 51d are electrically interconnected by connector devices which electrically interconnect the reflector parts in an indirect (capacitive) manner. Reflector part 51a is provided with connecting portion 51a′ in the form of a cavity in which a protruding connecting portion 51c′ of reflector part 51c and a connector device (58a, see FIG. 3c) are received, which capacitively interconnects reflector parts 51a and 51c. In a corresponding manner protruding connecting portion 51d′ of reflector part 51d is received together with a corresponding connector device in connecting portion 51a″ of reflector part 51a. The connector devices are illustrated in more detail in FIG. 3c.

FIG. 3b schematically shows a cross section view of an upper portion of the antenna arrangement in FIG. 3 (with more details shown than in FIG. 3). The cross section is taken just below high-band radiating element 55a (and the parallel high-band radiating elements of adjacent columns), which means that mid-band radiating elements 53b, 54b can also be seen. The second reflector part 51b is indirectly (capacitively) interconnected with the third and fourth reflector parts 51c-d in the same manner as described above with reference to the interconnection between reflector parts 51a, 51c and 51d, which description thus also applies here. The second reflector part 51b is furthermore provided with a base station module 59 at the back side thereof. Base station modules are known in the art, and base station module 59 is therefore merely schematically illustrated as a rectangle. The high-band radiating elements (55a for example) are electrically connected to the base station module. Thus, a complete high-band base station is formed.

The reflector parts 51a-d are elongated and extend in a lengthwise direction (depth direction in the figures) of the reflector/antenna and are arranged in parallel to form the backplane/reflector. The connector devices (58a for example) extend along the whole length of the respective reflector parts. Further, as can be seen in FIGS. 3a and 3b, reflector parts 51c, 51d are formed by two sub-parts which are electrically indirectly interconnected in a corresponding manner as described above with reference to the interconnection between reflector parts 51a and 51c. In other embodiments, reflector parts 51c, 51d may each be formed integrally in one piece, however.

FIG. 3c schematically shows a detail view of the interconnection between the mid-band and reflector part 51c and low-band reflector part 51a in FIG. 3a. It is noted that the interconnection between all adjacent reflector parts is achieved in the same manner in this embodiment. Reflector part 51a is provided with connecting portion 51a′ in the form of a cavity in which a protruding connecting portion 51c′ of reflector part 51c and a connector device 58a are received. Connector device 58a comprises two holding elements 58a′ and 58a″. A metallic film 58a′″ partly surrounds the periphery of holding element 58a′. The metallic film 58a′″ is arranged in abutment with connecting portions 51a′ and 51c′ of reflector parts 51a, 51c to achieve the electrical interconnection. The holding element 58a′ has holding portions facing/connecting to the connecting portions with the metallic film 58a′″ sandwiched therebetween. The metallic film is provided with a dielectric coating/layer arranged on the metallic film the side thereof facing the connecting portions to achieve indirect/capacitive interconnection via the film. The holding elements 58a′, 58a″ are non-conductive. The metallic film 58a′″ is attached to the holding element 58a′ by means of an adhesive coating/layer on the side thereof facing the holding element to adhere thereto. Holding element 58a′ is made from a resilient material to force the metallic film against the connecting portions to minimize air gaps. Holding element 58a″ is however not resilient to any substantial degree and only acts as a spacing and electrically insulating element. In an alternative embodiment, holding elements 58a′ and 58a″ are formed in one piece, for instance as a substantially U-shaped resilient element into which 51c′ is received.

Just like in the embodiment in FIG. 2, the reflector for each radiating element is formed not only by the reflector part which the radiating element is attached to, but also by adjacent reflector parts.

A backplane/reflector being formed from indirectly interconnected reflector parts as shown in FIG. 3, 3a-c, and alternative solutions for indirect interconnection of reflector parts, is described in more detail in applicants' co-pending application SE2051458-4, which is hereby incorporated by reference.

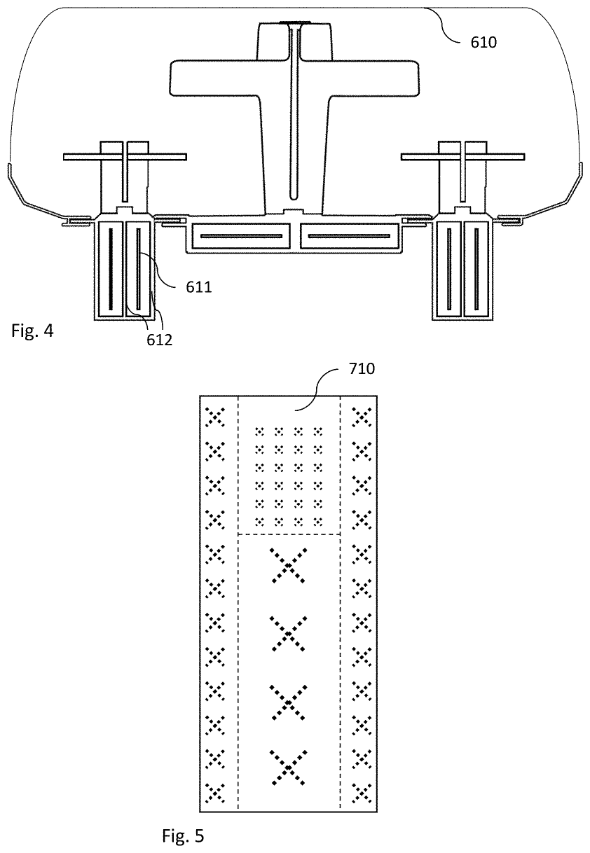

FIG. 4 schematically shows a cross section view of a lower portion of an antenna arrangement corresponding to FIG. 3 except that the antenna feeding network modules comprise stripline technology, and in that the antenna arrangement comprises a radome 610 covering the radiating elements. Thus, all antenna feeding network modules which are electrically connected to the radiating elements are different in the sense that the modules are formed as striplines instead of coaxial lines. The transmission lines of the antenna feeding network modules comprise flat conductors/strips (611 for example) placed between two ground planes (612 for example). The striplines have the same function as the coaxial lines in FIG. 3. The spaces between the flat conductors/strips and the ground planes are substantially air filled.

FIG. 5 schematically shows a front view of an embodiment of a multi-array antenna arrangement corresponding to FIG. 3 except being shown with a radome 710 being common for all arrays/reflector parts.

According to an aspect of the invention, a system for cellular communication includes at least one mobile communication device (such as a cellular phone) and a multi-array antenna arrangement described herein above, wherein the mobile communication device communicates wirelessly with the multi-array antenna arrangement.

The description above and the appended drawings are to be considered as non-limiting examples of the invention. The person skilled in the art realizes that several changes and modifications may be made within the scope of the invention. For example, the number of columns and/or number of radiating elements in each array may be varied. Furthermore, in embodiments where reflector parts are interconnected, the reflector parts may be directly/galvanically interconnected or indirectly interconnected or a combination thereof. Furthermore, the number of coaxial lines illustrated in the embodiments are merely illustrative, and may vary depending on the requirements.

1. A multi-array antenna arrangement comprising:
a backplane having a lower end and an upper end defining a height direction therebetween,
at least one array comprising low-band radiating elements arranged at the front of the backplane;
at least one array comprising mid-band radiating elements arranged at the front of the backplane;
at least one array comprising high-band radiating elements arranged at the front of the backplane in the vicinity of the upper end thereof;
wherein at least one of the low-band and/or mid-band radiating elements is arranged at equal or higher height than an uppermost of the high-band radiating elements.

2. The multi-array antenna arrangement according to claim 1, wherein at least one of the arrays comprises low-band and mid-band radiating elements in the form of combined radiating elements, each combined radiating element having low-band radiating parts and mid-band radiating parts.

3. The multi-array antenna arrangement according to claim 2, wherein the at least one array comprising combined radiating elements further comprises mid-band radiating elements.

4. The multi-array antenna arrangement according to claim 1, wherein the at least one low-band and/or mid-band radiating element is arranged with its base at equal or higher height than the base of the uppermost of the high-band radiating elements.

5. The multi-array antenna arrangement according to claim 1, wherein at least one of the mid-band radiating elements is arranged at equal or higher height than an uppermost of the high-band radiating elements.

6. The multi-array antenna arrangement according to claim 1, wherein one or more of the at least one array comprising low-band radiating elements and/or one or more of the at least one array comprising mid-band radiating elements is arranged on at least one lateral side of one or more of the at least one array comprising high-band radiating elements.

7. The multi-array antenna arrangement according to claim 1, wherein at least one first array and at least one second array of radiating elements are arranged at opposite lateral sides of one or more of the at least one array comprising high-band radiating elements, each first array and second array being one of the at least one array comprising low-band radiating elements or one of the at least one array comprising mid-band radiating elements.

8. The multi-array antenna arrangement according to claim 7, wherein one or more of the at least one array comprising low-band radiating elements and/or one or more of the at least one array comprising mid-band radiating elements is arranged below one or more of the at least one array of high-band radiating elements.

9. The multi-array antenna arrangement according to claim 1, wherein the backplane is formed by at least two interconnected parts.

10. The multi-array antenna arrangement according to claim 1, wherein the backplane comprises at least two electrically conducting reflector parts, each being configured to co-act with at least one of the arrays.

11. The multi-array antenna arrangement according to claim 10, wherein at least two of the electrically conducting reflector parts are directly and/or indirectly electrically interconnected.

12. The multi-array antenna arrangement according to claim 10, wherein one or more first reflector part is arranged to co-act with one or more of the at least one array comprising low-band radiating elements and/or with one or more of the at least one array comprising mid-band radiating elements, and wherein one or more second reflector part is arranged to co-act with one or more of the at least one array comprising high-band radiating elements.

13. The multi-array antenna arrangement according to claim 12, wherein at least one second reflector part is arranged with a lateral side facing at least one first reflector part.

14. The multi-array antenna arrangement according to claim 12, comprising at least two first reflector parts, each being arranged to co-act with one or more of the at least one array comprising low-band radiating elements and/or with one or more of the at least one array comprising mid-band radiating elements, the at least two first reflector parts being directly or indirectly electrically interconnected.

15. The multi-array antenna arrangement according to claim 12, wherein at least one first reflector part and at least one second reflector part are directly and/or indirectly electrically interconnected.

16. The multi-array antenna arrangement according to claim 10, wherein at least one reflector part along with at least one of the arrays forms part of a multi-radiator antenna having its reflector formed partly by the reflector part and partly by one or more adjacent reflector parts.

17. The multi-array antenna arrangement according to claim 11, wherein at least two of the electrically conducting reflector parts each is provided with at least one connecting portion, further comprising at least one connector device adapted to provide an electrical interconnection between the at least two of the reflector parts, each connector device comprising
a metallic film adapted to be arranged in abutment with connecting portions of the at least two of the reflector parts to achieve the electrical interconnection, and
one or more holding elements, wherein at least one of the holding elements has at least one holding portion adapted to connect to a connecting portion of a reflector part with the metallic film sandwiched therebetween,
wherein the electrical interconnection is indirect by means of a dielectric coating or layer arranged on the metallic film and/or on the connecting portions, or by means of a dielectric film arranged between the metallic film and the connecting portions.

18. The multi-array antenna arrangement according to claim 1, further comprising at least one antenna feeding network module, each antenna feeding network module being electrically connected to one or more of the at least one array comprising low-band radiating elements and/or to one or more of the at least one array comprising mid-band radiating elements and/or to one or more of the at least one array comprising high-band radiating elements.

19. The multi-array antenna arrangement according to claim 18, wherein the antenna feeding network module comprises at least one transmission line being a coaxial line having at least one inner conductor being at least partly surrounded by an elongated outer conductor with air therebetween.

20. The multi-array antenna arrangement according to claim 18, wherein the antenna feeding network module comprises at least one transmission line having at least one flat conductor placed between two ground planes or essentially interacting only with one ground plane.

21. The multi-array antenna arrangement according to claim 18, wherein the antenna feeding network module comprises at least one transmission line being a flexible coaxial cable using for instance PTFE (polytetrafluoroethylene) or PE (polyethylene) as dielectric.

22. The multi-array antenna arrangement according to claim 1, further comprising at least one base station module, wherein one or more of the at least one array comprising high-band radiating elements is electrically connected to the base station module.

23. The multi-array antenna arrangement according to claim 1, wherein the low-band radiating elements are configured to transmit and receive signals at one or more first frequency bands being below 1 GHz, and wherein the mid-band radiating elements are configured to transmit and receive signals at one or more second frequency bands being within an interval from 1.0-3.0 GHz, and wherein the high-band radiating elements are configured to transmit and receive signals at one or more third frequency bands being above 3.0 GHz.

24. The multi-array antenna arrangement according to claim 1, wherein the radiating elements of at least one of the arrays are separated by less than one wavelength.

25. The multi-array antenna arrangement according to claim 1, wherein the radiating elements of two columns of radiating elements are separated by at least half a wavelength.

26. The multi-array antenna arrangement according to claim 1, wherein the arrays of low-band, mid-band and high-band radiating elements are arranged behind a radome.

27. The multi-array antenna arrangement according to claim 1, wherein one or more of the at least one array comprising low-band radiating elements and/or one or more of the at least one array comprising mid-band radiating elements and one or more of the at least one array comprising high-band radiating elements are arranged behind a common radome.

28. The multi-array antenna arrangement according to claim 1, wherein all of the arrays are arranged behind a common radome.

29. The multi-array antenna arrangement according to claim 1, wherein the radiators of the arrays are cross-polarized.

30. A system for cellular communication comprising:
at least one mobile communication device; and
a multi-array antenna arrangement in wire-less communication with said at least one mobile communication device, the multi-array antenna arrangement having:
a backplane having a lower end and an upper end defining a height direction therebetween,
at least one array comprising low-band radiating elements arranged at the front of the backplane;
at least one array comprising mid-band radiating elements arranged at the front of the backplane;
at least one array comprising high-band radiating elements arranged at the front of the backplane in the vicinity of the upper end thereof;
wherein at least one of the low-band and/or mid-band radiating elements is arranged at equal or higher height than an uppermost of the high-band radiating elements.
